(19) United States
(12) Patent Application Publication
(10) Pub. No.: US 2008/0219868 A1
(43) Pub. Date: Sep. 11, 2008

(54) Linear Compressor Cylinder and Head Construction

(76) Inventors: Brian Robert Bonniface, Auckland (NZ); Mark Jon English, Auckland (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/996,022

(22) PCT Filed: Jul. 21, 2006
(86) PCT No.: PCT/NZ2006/000183

§ 371 Date: Mar. 31, 2008

(30) Foreign Application Priority Data
Jul. 21, 2005 (NZ) 541407

(51) Int. Cl. F01B 31/28; F04B 17/03; B23P 15/00

(52) U.S. Cl. 417/415; 92/169.1; 92/171.1; 29/888.02

(57) ABSTRACT

A cylinder assembly for a linear compressor includes a cylinder chassis with an inner surface defining a cylinder space extending along an axis from a cylinder head end. The cylinder space is at least substantially cylindrical. A cylindrical cylinder liner, open at both ends is located within the chassis. The outer surface of the liner is engaged against the cylinder space defining portion of the inner surface of the chassis. A valve plate is being bonded or fused to the cylinder head end of the cylinder liner. The valve plate sealingly closes the cylinder head end of the cylinder space.

### FIELD OF THE INVENTION

The present invention relates to linear compressors, and in particular linear compressors of the type suitable for use in a vapour compression refrigeration system.

### BACKGROUND TO THE INVENTION

Linear compressors of a type for use in a vapour compression refrigeration system are the subject of many documents in the prior art. One such document is our co-pending PCT patent application PCT/NZ2004/000108. That specification describes a variety of developments relating to compressors, many of which have particular application to linear compressors. The present invention relates to further improvements to compressor embodiments such as those described in that patent application. Accordingly that application provides a general exemplification of a compressor to which the present invention may be applied. However the present invention may also be applied beyond the scope of the particular embodiments of a linear compressor disclosed in that application. Persons skilled in the art will appreciate the general application of the ideas herein to other embodiments of linear compressors such as are found in the prior art.

The present invention relates generally to cylinder part assemblies.

### SUMMARY OF THE INVENTION

It is an object of the present invention to provide a cylinder part assembly with improved characteristics with particular application to linear compressors, and/or a linear compressor including an improved cylinder part assembly or to at least provide the industry with a useful choice.

In a first aspect the invention consists in a cylinder assembly for a linear compressor comprising:

a cylinder chassis including an inner surface defining a cylinder space extending along an axis from a cylinder head end, said cylinder space being at least substantially cylindrical,

a cylindrical cylinder liner, open at both ends and located within said chassis, such that the outer surface of said liner is engaged against the cylinder space defining portion of said inner surface of said chassis, and

a valve plate, said valve plate being bonded or fused to cylinder head end of said cylinder liner to sealingly close said cylinder head end of said cylinder space.

According to a further aspect of the invention said valve plate is glued to said cylinder liner.

According to a further aspect of the invention the end surface of said liner butts a face of said valve plate.

According to a further aspect of the invention said cylinder chassis inner surface also defines a cylinder head space, and the outer edge of said valve plate is flush with or inside the outer surface of said cylinder liner.

In a further aspect the present invention consists in a refrigeration system compressor comprising a hermetic housing, a linear compressor within said hermetic housing, said compressor including a cylinder part assembly at least in part defined according to one or more of the above paragraphs, a piston part including a piston for reciprocating within the cylinder defined by said cylinder liner, and a linear electric motor for driving reciprocating movement between the piston part and cylinder part, with the linear compressor suspended for operation within said hermetic housing.

In a still further aspect the present invention consists in a method of manufacturing a linear compressor, including, for assembling the cylinder portion thereof, the steps of:

fusing or bonding a valve plate to a cylinder liner, to be a cylinder liner assembly,
by differential temperature, expanding a cylinder chassis relative to said cylinder liner assembly,

inserting said cylinder liner assembly into said cylinder chassis through an open end to engage said valve plate against said cylinder chassis, and

retaining a said cylinder liner assembly in this position until said cylinder chassis and said cylinder liner assembly become engaged as said temperature differential reduces.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

FIG. 1 is a side elevation in cross-section of a linear compressor with a cylinder part assembly incorporating the invention according to one preferred embodiment.

FIG. 2 is an external perspective of the cylinder head end portion of the cylinder part according to one preferred embodiment of the present invention.

FIG. 3 is a cross-section side elevation of the cylinder part portion of FIG. 2 according to one embodiment of the present invention.

FIG. 4 is a plan elevation in cross-section of a linear compressor with a cylinder part assembly incorporating the invention according to another embodiment.

### DETAILED DESCRIPTION

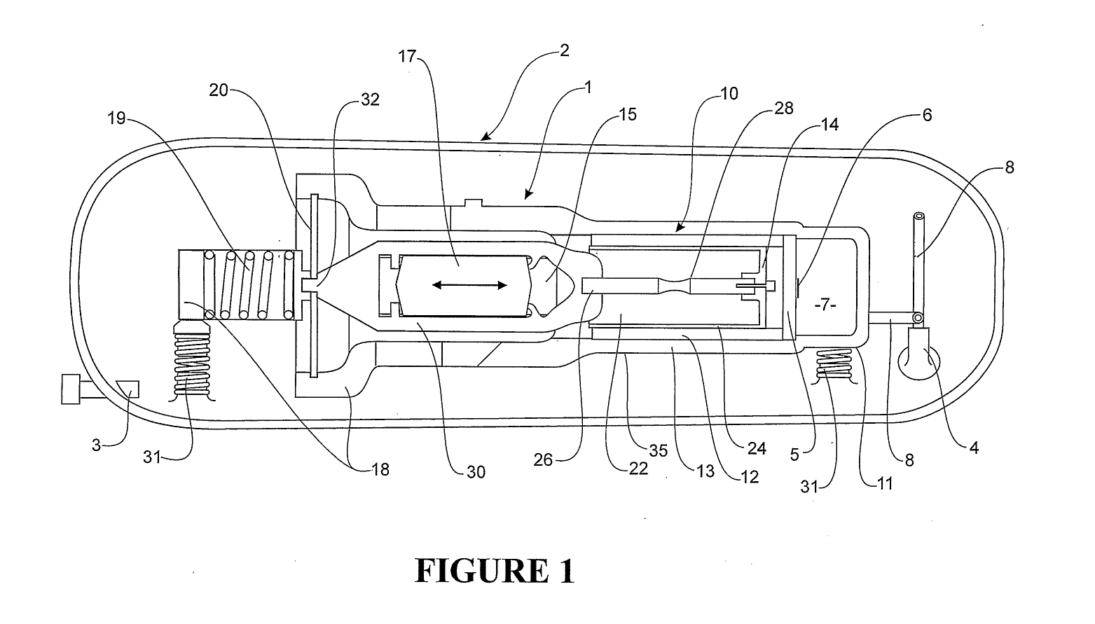

Referring to FIG. 1 the compressor for a vapour compression refrigeration system includes a linear compressor 1 supported inside a housing 2. Typically the housing 2 is hermetically sealed and includes a gases inlet port 3 and a compressed gases outlet port 4. Uncompressed gases flow within the interior of the housing, surrounding the compressor 1. These uncompressed gases are drawn into the compressor during intake stroke, compressed between the piston crown 14 and outlet valve plate 5 on the compression stroke and expelled through discharge valve 6 into a compressed gases manifold 7. Compressed gases exit the manifold 7 to the outlet port 4 in the shell through a flexible tube 8. To reduce the stiffness effect of discharge tube 8 the tube is preferably arranged as a loop or spiral transverse to the reciprocating axis of the compressor.

The intake to the compression space may be through the piston (with an aperture and valve in the crown) or through the head, divided to include suction and discharge manifolds and valves. However, the present invention is most advantageous when applied to the former arrangement where the head only accommodates a discharge space.

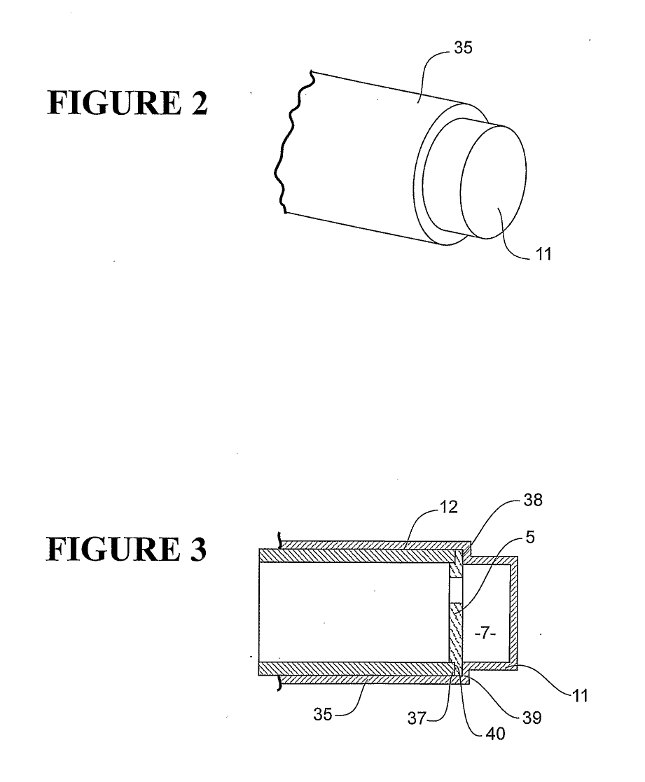

The illustrated linear compressor 1 has, broadly speaking, a cylinder part and a piston part connected by a main spring. The cylinder part includes cylinder chassis 10, cylinder head 11, valve plate 5 and a cylinder liner 12. The cylinder part also includes stator parts 15 for a linear electric motor. An end portion 18 of the cylinder part, distal from the head 11, mounts the main spring relative to the cylinder part. In the embodiment illustrated in FIG. 1 the main spring is formed as a combination of coil spring 19 and flat spring 20. In the embodiment illustrated in FIG. 2 the main spring is a combination of flat springs 16.

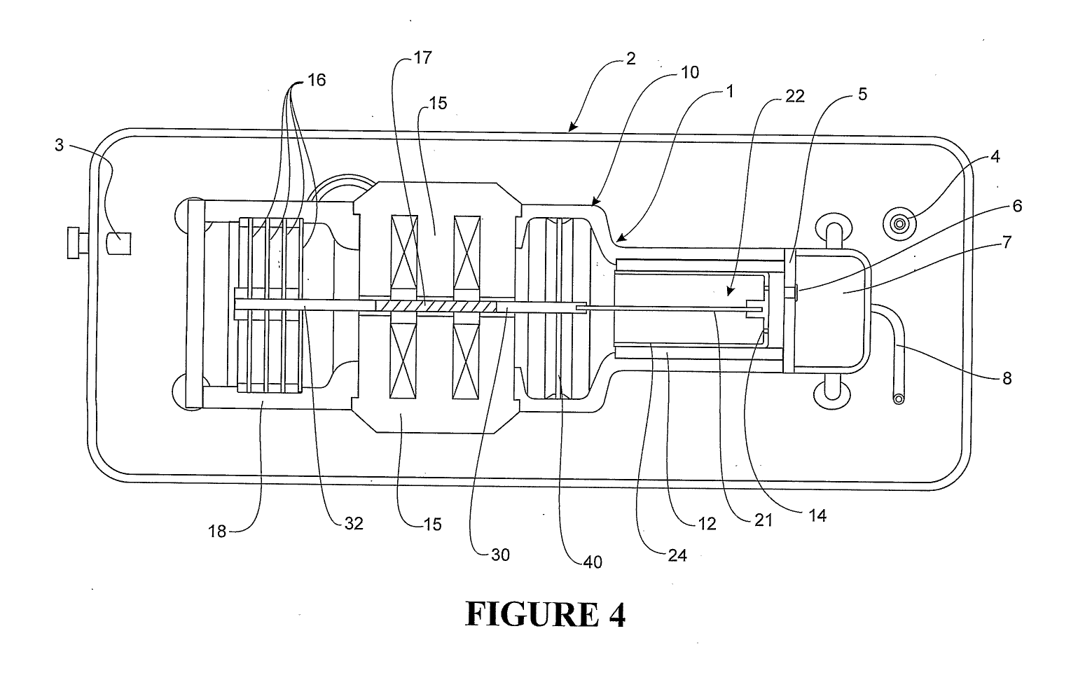

The piston part includes a hollow piston 22 with sidewall 24 and crown 14. A rod connects between the crown 14 and a supporting body 30 for linear motor armature 17. In FIG. 1 the rod has a flexible portion 28 in approximately the centre of the hollow piston 22. In FIG. 4 the rod 21 is flexible along its full length.

The linear motor armature 17 comprises a body of permanent magnet material (such as ferrite or neodymium) magnetised to provide one or more poles directed transverse to the axis of reciprocation of the piston within the cylinder liner. An end portion 32 of armature support 30 which is distal from the piston 22 is connected with the main spring.

The armature may be supported at one end by the main spring, and at the other end only be the piston, as in FIG. 1. Alternatively the armature may include additional lateral support such as intermediate flat spring 40, in FIG. 4.

The linear compressor 1 is mounted within the shell 2 on a plurality of suspension springs to isolate it from the shell. In use the large outer body of the linear compressor, the cylinder part, will oscillate along the axis of reciprocation of the piston part within the cylinder part. In the preferred compressor the piston part is purposely kept very light compared to the cylinder part so that the oscillation of the cylinder part is small compared with the relative reciprocation between the piston part and cylinder part. In the illustrated form the linear compressor is mounted on a set of four suspension springs 31 generally positioned around the periphery. Alternate suspension spring arrangements are illustrated in PCT/NZ2004/000108. The ends of each suspension spring fit over elastomeric snubbers connected with the linear compressor 1 at one end of each spring and connected with the compressor shell 2 at the other end of each spring.

This briefly describes a linear compressor of a type for which the improved head assembly of the present invention is useful. However it will be appreciated that the usefulness of the present invention is not restricted to linear compressors of the type and configuration illustrated. The improvement is generally applicable.

The relevant portion of the linear compressor illustrated in FIG. 1 is further illustrated in FIGS. 2 and 3.

In this embodiment the head cover is incorporated in the main chassis component of the cylinder part 10. Preferably it is incorporated as an integral part, for example cast integrally with the remainder of the frame when the frame is manufactured. Thus the head 11 appears as a cap enclosing one end of cylinder body 35.

A valve plate is secured in position within the cylinder chassis to divide a head portion of the space therein from a cylinder portion of the space therein. The valve plate includes at least a discharge valve aperture, and preferably carries a discharge valve fixed on one side.

The inner surface of the cylinder portion 35 of the chassis is preferably cylindrical and the outer perimeter of the valve plate is preferably circular and sized to fit closely within the cylindrical surface.

The cylinder liner 12 has a cylindrical outer surface sized to have an interference fit within the inner surface of cylinder portion 35. This provides that when the cylinder liner 12 and the cylindrical portion 35 of the cylinder chassis are at the same or similar temperature, and the cylinder liner 12 is in place within the cylinder chassis, the two parts are tightly engaged without requirement for further fixing or fastening.

The periphery of valve plate 5 is engaged between the end 37 of cylinder liner 12 and the cylinder chassis. Preferably the cylinder chassis includes an annular shoulder 39 and the shoulder 39 and end 37 of the cylinder liner directly engage opposite sides of the periphery 38 of the valve plate. Alternatively a plurality of shoulder portions may be provided distributed around the periphery of the valve plate. An intermediate spacer may be provided between the cylinder chassis and the valve plate 5.

The valve plate 5 may be provided with an annular rebate 40 at periphery 38 to receive the end of cylinder liner 12.

The valve plate 5 is secured to the open end of the cylinder liner 12. The valve plate may be secured by way of fusing or bonding, to create a permanent bond and an integral seal. The bond or fusion seal eliminates the need for a gasket or similar compressible seal. The fusion may be by way of welding or brazing. Typical welding processes would involve high temperatures and may alter the geometry of the cylinder to too great an extent. However friction welding may be feasible. Alternatively lower temperature process such as soldering, silver solder or brazing may be used. For example, a preformed ring of solder or brazing may be held between the valve plate and the end of the cylinder liner. This assembly may then be heated, for example in an oven, to a temperature above the melt temperature of the filler material. When the assembly is removed from the oven the assembly cools and the filler material solidifies, fixing the valve plate to the end of the cylinder liner.

Alternatively, bonding may be by way of suitable glue, adhesive or solder. Suitable adhesives include epoxy glues (such as Araldite XP3131) or anaerobic thermosetting glues such as a cyanoacrylate (superglue). Bonding with glues should be conducted according to methods appropriate to the glue concerned.

The same improvement, bonding or fusing the valve plate to the end of the cylinder liner may be applied to the alternative compressor embodiment illustrated in FIG. 4. In this embodiment the compressor includes a separate head cover. The valve plate periphery extends beyond the outer edge of the cylinder liner to overlap the end of the cylinder chassis. In this embodiment the valve plate may include apertures for the passage of set screws or similar fasteners that secure the head cover to the other side of the valve plate and to the cylinder assembly.

The preferred method of assembly of the compressor according to FIG. 1 involves bonding or fusing the valve plate to the cylinder liner. The cylinder chassis (which is typically cast aluminium alloy) is then heated. The cylinder liner assembly is introduced within the cylindrical cavity for the valve plate to butt against the shoulder 39. The cylinder liner assembly is retained there until the cylinder shrinks onto it. With reasonable manufacturing tolerances it should be possible to achieve this consistently and with very effective eventual engagement between the cylinder liner 12 and the cylinder chassis by heating the cylinder chassis to approximately 250° C. and leaving the liner at room temperature.

Securing the valve plate to the cylinder liner by fusing or gluing provides a seal between the two that is dimensionally stable. A typical gasket seal of the prior art compresses during assembly. It is difficult to size and locate the aperture of the gasket sufficiently accurately to have it perfectly flush with the cylinder wall but not intruding. With an oversized aperture the volume of the compression space (where the piston is at the top of its maximum stroke) may be larger than desirable. With an undersized aperture the gasket protrudes beyond the cylinder wall, and the piston must be sized to have sufficient clearance to avoid any possible protrusion. The seal according to the present invention can avoid these disadvantages.

The invention provides a cylinder assembly for a linear compressor. The cylinder assembly includes a cylinder chassis with an inner surface defining a cylinder space extending along an axis from a cylinder head end. The cylinder space is at least substantially cylindrical. A cylindrical cylinder liner, open at both ends, is located within the chassis. The outer surface of the liner is engaged against the cylinder space defining portion of the inner surface of the chassis. A valve plate is bonded or fused to the cylinder head end of the cylinder. The valve plate liner sealingly closes the cylinder head end of the cylinder space. The valve plate is preferably welded to the cylinder liner. Alternatively the valve plate is glued to the cylinder liner.

The end surface of the liner preferably butts a face of the valve plate.

The cylinder chassis inner surface preferably also defines a cylinder head space, and the outer edge of the valve plate is flush with or inside the outer surface of the cylinder liner.

Alternatively the linear compressor includes a head fixed to the cylinder chassis, and the valve plate extends beyond the edge of the cylinder liner.

The cylinder chassis preferably extends beyond the other end of the cylinder liner, and may carry, for example, stator parts of a linear motor. Alternatively the cylinder chassis may end intermediate the ends of the cylinder liner, to cover only a portion of the outer surface of the cylinder liner. In that case a separate cylinder part frame may be fixed over the other end of the cylinder liner, for example with an interference friction fit. The cylinder part frame may carry the stator parts of a linear motor.

The cylinder liner preferably is an interference fit within the chassis and is held in place by friction.

The chassis preferably includes, at a transition between the cylinder defining part of the inner surface and the head defining part of the inner surface, a shoulder or shoulders, and the valve plate is pressed between the shoulder or shoulders at one side and the annular end of the cylinder liner at its other side.

The valve plate may include one or more valve members assembled to it.

One or more grooves in either the inner surface of the cylinder chassis or the outer surface of the cylinder liner may define supply passages to supply compressed gases to gas bearing ports formed in the cylinder liner. Preferably these grooves are provided in the outer surface of the cylinder liner, for example as described in our PCT Application WO 02/35093. In that case one or more notches are preferably provided in the periphery of the valve plate to define a flow path between the compressed gases discharge space and the head and the gas bearing supply passages defined between the chassis and the liner.

The cylinder assembly is particularly for inclusion in a refrigeration system compressor comprising a hermetic housing and a linear compressor within the hermetic housing. The compressor includes the cylinder part assembly, a piston part including a piston for reciprocating within the cylinder defined by the cylinder liner, and a linear electric motor for driving reciprocating movement between the piston part and cylinder part. The linear compressor is suspended for operation within the hermetic housing.

The cylinder assembly allows for an improved method of manufacturing a linear compressor, in particularly a method for assembling the cylinder portion thereof.

The method begins with fusing or bonding a valve plate to a cylinder liner, to be a cylinder liner assembly. Then, by differential temperature, a cylinder chassis is expanded relative to the cylinder liner assembly. The cylinder liner assembly is inserted into the expanded cylinder chassis through an open end, to engage the valve plate against the cylinder chassis.

The cylinder liner assembly is retained in this position until the cylinder chassis and the cylinder liner assembly become engaged as the temperature differential reduces.

1. A cylinder assembly for a linear compressor comprising:
a cylinder chassis including an inner surface defining a cylinder space extending along an axis from a cylinder head end, said cylinder space being at least substantially cylindrical,
a cylindrical cylinder liner, open at both ends and located within said chassis, such that the outer surface of said liner is engaged against the cylinder space defining portion of said inner surface of said chassis, and
a valve plate, said valve plate being bonded or fused to cylinder head end of said cylinder liner to sealing close said cylinder head end of said cylinder space.

2. A cylinder assembly as claimed in claim 1 wherein said valve plate is welded to said cylinder liner.

3. A cylinder assembly as claimed in claim 1 wherein said valve plate is glued to said cylinder liner.

4. A cylinder assembly as claimed in claim 1 wherein end surface of said liner butts a face of said valve plate.

5. A cylinder assembly as claimed in claim 1 wherein said cylinder chassis inner surface also defines a cylinder head space, and the outer edge of said valve plate is flush with or inside the outer surface of said cylinder liner.

6. A cylinder assembly as claimed in claim 5 wherein said chassis includes, at a transition between said cylinder defining part of said inner surface and said head defining part of said inner surface, a shoulder or shoulders, and said valve plate is pressed between said shoulder or shoulders at one side and the annular end of said cylinder liner at its other side.

7. A cylinder assembly as claimed in claim 1 wherein said linear compressor includes a head fixed to said cylinder chassis, and said valve plate extends beyond the edge of said cylinder liner.

8. A cylinder assembly as claimed in claim 1 wherein said cylinder chassis extends beyond the other end of said cylinder liner, and carries stator parts of a linear motor.

9. A cylinder assembly as claimed in claim 1 wherein said cylinder chassis ends intermediate the ends of said cylinder liner, to cover only a portion of the outer surface of the cylinder liner.

10. A cylinder assembly as claimed in claim 9 wherein a separate cylinder part frame is fixed over the other end of the cylinder liner and carries stator parts of a linear motor.

11. A cylinder assembly as claimed in claim 1 wherein said cylinder liner is an interference fit within said chassis and is held in place by friction.

12. A cylinder assembly as claimed in claim 1 wherein the valve plate may include one or more valve members assembled to it.

13. A cylinder assembly as claimed in claim 1 wherein one or more grooves in either the inner surface of the cylinder chassis or the outer surface of the cylinder liner define supply passages to supply compressed gases to gas bearing ports formed in the cylinder liner.

14. A cylinder assembly as claimed in claim 13 wherein said grooves are provided in the outer surface of the cylinder liner, and one or more notches in the periphery of the valve plate define a flow path between the compressed gases discharge space of the head and the gas bearing supply passages defined between the chassis and the liner.

15. A refrigeration system compressor comprising a hermetic housing, a linear compressor within said hermetic housing, said compressor including a cylinder part assembly as claimed in any one of claims 1 to 13, a piston part including a piston for reciprocating within the cylinder defined by said cylinder liner, and a linear electric motor for driving reciprocating movement between the piston part and cylinder part, with the linear compressor suspended for operation within said hermetic housing.

16. A method of manufacturing a linear compressor, including, for assembling the cylinder portion thereof, the steps of:
fusing or bonding a valve plate to a cylinder liner, to be a cylinder liner assembly, by differential temperature, expanding a cylinder chassis relative to said cylinder liner assembly,
inserting said cylinder liner assembly into said cylinder chassis through, an open end to engage said valve plate against said cylinder chassis, and
retaining a said cylinder liner assembly in this position until said cylinder chassis and said cylinder liner assembly become engaged as said temperature differential reduces.
